(19) United States
(12) Patent Application Publication
(10) Pub. No.: US 2004/0204241 A1
(43) Pub. Date: Oct. 14, 2004

(54) Virtual vegas video keyboard

(76) Inventor: Lori A. Houston, Houston, TX (US)

Correspondence Address: WONG, CABELLO, LUTSCH, RUTHERFORD & BRUCCULERI,, P.C., 20333 SH 249, SUITE 600, HOUSTON, TX, 77070, US

(21) Appl. No.: 09/970,427

(22) Filed: Oct. 3, 2001

(51) Int. Cl. A63F 13/02

(52) U.S. Cl. 463/37

(57) ABSTRACT

A self contained gaming keyboard and interface that is used to direct and control standard or non-standard personal computer, networked computer or distributed server to enable the play of a plurality of gaming, casino-like action and gambling software. This device independent keyboard replaces the existing keyboard and mouse to emulate a more real and life like experience when playing casino wagering games such as; video poker, video blackjack, video roulette, video slot machine and others. This keyboard follows the same general format of appearance and functionality as used in the gaming industry to select, bet, draw, discard, hold, spin, reset, cash out and other actions necessary to play a plurality of said gaming software.

### BACKGROUND OF THE INVENTION

The Computer Gaming Keyboard invention described herein generally relates to a gambling or gaming system, or more particularly, a game controlling device that is used to interact with and control the actions of a variety of casino-like software games played on the personal computer.

Legalized gambling revenues continue to climb at a rate of 20% per year. Over 40 states have lotteries, twenty-five have casinos, and nearly all fifty states have sanctioned gambling of some sort. Today, gaming related revenues are estimated to exceed 1 trillion dollars.

Travel to brick and mortar casino locations can be expensive and impractical for many gaming enthusiasts. Further, these operations are almost entirely wager based, meaning that you cannot just “play for fun”.

While relatively new, on-line and software enabled gaming is already a 100 billion dollar industry. Additionally, today over 50% of all households in the United States have computers and most of these have some form of access to the Internet. This combination sets the stage for explosive growth for gaming use on the home computer.

Where virtual casino operations that reside on the Internet, along with manufacturers and distributors of casino-like gaming software can provide an affordable and entertaining alternative to brick and mortar casinos, the thrill of a Las Vegas style casino is hard to duplicate with a standard keyboard and point & click mouse.

To date, game play on the personal computer has been primarily driven by software, and controlled using standard QWERTY keyboard and mouse controllers. Joysticks emulating coin-operated video games are also available as a means of better control and invoking more realistic game play, but still fall short of the actual controls of a real video poker or slot machine.

Hence there is a need for a control board that can be used by the casual gambler to simulate the casino excitement and experience in the privacy of their own home. To this end, there is a need for such a device to be easy to use, simple to configure and operate using standard computer hardware, port inputs and software from various game manufacturers as to not become quickly outdated.

### SUMMARY OF THE INVENTION

The aforementioned needs are satisfied by the computer gaming keyboard invention described in detail herein.

The described computer gaming keyboard invention is a standard size computer keyboard controller and interface that replaces the existing keyboard , mouse and or video game controller. The present invention operates using standard USB port and Microsoft Windows compatibility that affords easy connection and playability on any home computer. Since this invention can be used to play virtually any Windows compatible casino on-line or software, there is no risk of incompatibility or it being outdated for use with your favorite program.

This computer gaming keyboard connects in-line to the host computer using standard Universal Serial Bus (USB) port connectors. Normal QWERTY keyboard operations will not be interrupted or halted during use. The gaming keyboard can remain attached while the computer is turned off.

The computer gaming keyboard is designed to enhance the gambling fans' experience while playing casino games such as Black Jack, Slots, and Video Poker. The gaming keyboard is used to select, bet, draw, deal, reset, cash out, hold cards, spin, and other actions necessary to facilitate the format and appearance of top casino games. Each mode is independent and can be accessed at the touch of a button.

In another aspect of the present invention, the power requirements are standard as well, using URL approved, 120 volt regulated power to ensure that the device is safe and will work properly in most households.

These and other objects and advantages of the present invention will become more fully apparent from the following description taken in conjunction with the accompanying drawings.

### BRIEF DESCRIPTION OF THE DRAWINGS

Considering the attached drawings, wherein like reference numerals denote throughout various drawings of the attached visual descriptions:

FIG. 1 is a top-level, front-level and side-level illustration showing the approximate dimensions of the computer gaming keyboard and inherent controlling buttons and LCD;

FIG. 2 is a co-branding example of the system in FIG. 1 lit to demonstrate the computer gaming keyboard in video poker mode;

FIG. 3 illustrates a working prototype example of the computer gaming keyboard with LCD display, lit in action on mode;

FIG. 4 is a working prototype basic model that does NOT include the LCD display, lit in action on mode (in this example, the controls would be identified by the computer screen and corresponding lit button on the computer gaming keyboard);

FIG. 5 is an illustration that shows the computer gaming keyboard connected to a standard computer and monitor for use with video poker software.

### DETAILED DESCRIPTION OF THE INVENTION

Reference will now be made to the drawings wherein like numerals refer to like parts and descriptions throughout.

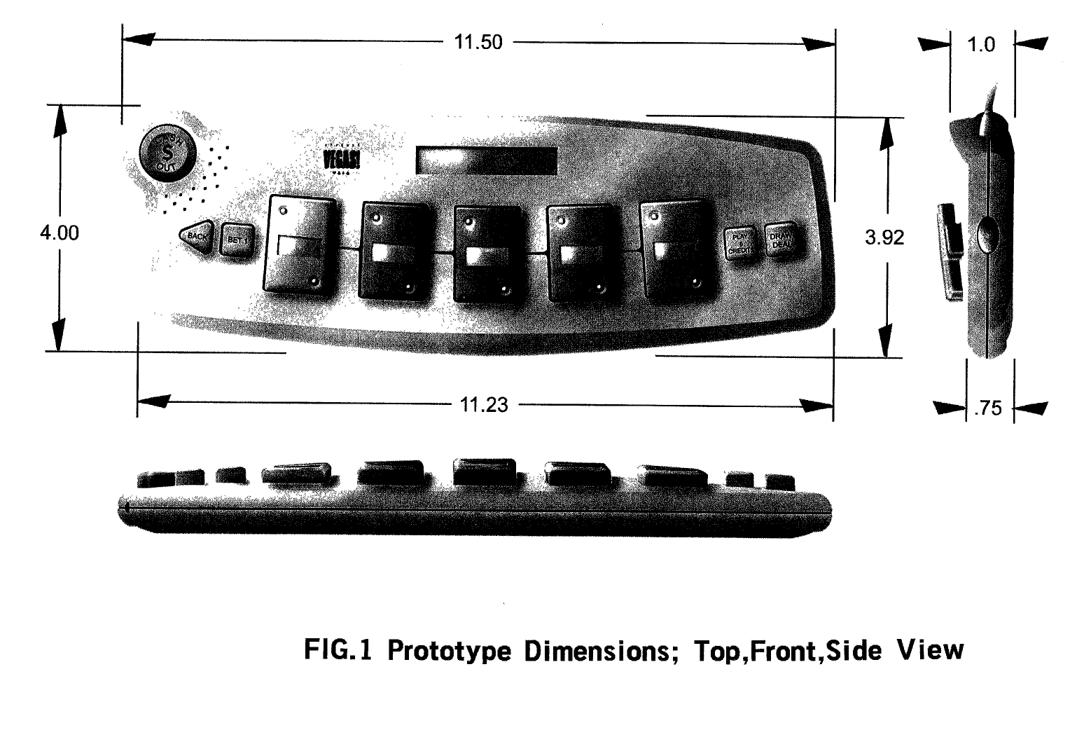

FIG. 1 is a prototype schematic drawing with approximate dimensions. This illustration shows the essential layout and design of the invention that includes a housing formed as a rectangular casing, similar in size and shape to a standard computer keyboard. The five (5) primary decision buttons shown control the basic functions of hit, stand, select, spin, hold, discard, bet, depending upon the game being played as will be illustrated in subsequent drawings. The smaller buttons to the right and left of the primary decision buttons can be used to denote single bet increments, bet all denotations, reset, cash out, draw/deal and back one step. These buttons correspond with the actual visual of the software images on the computer screen.

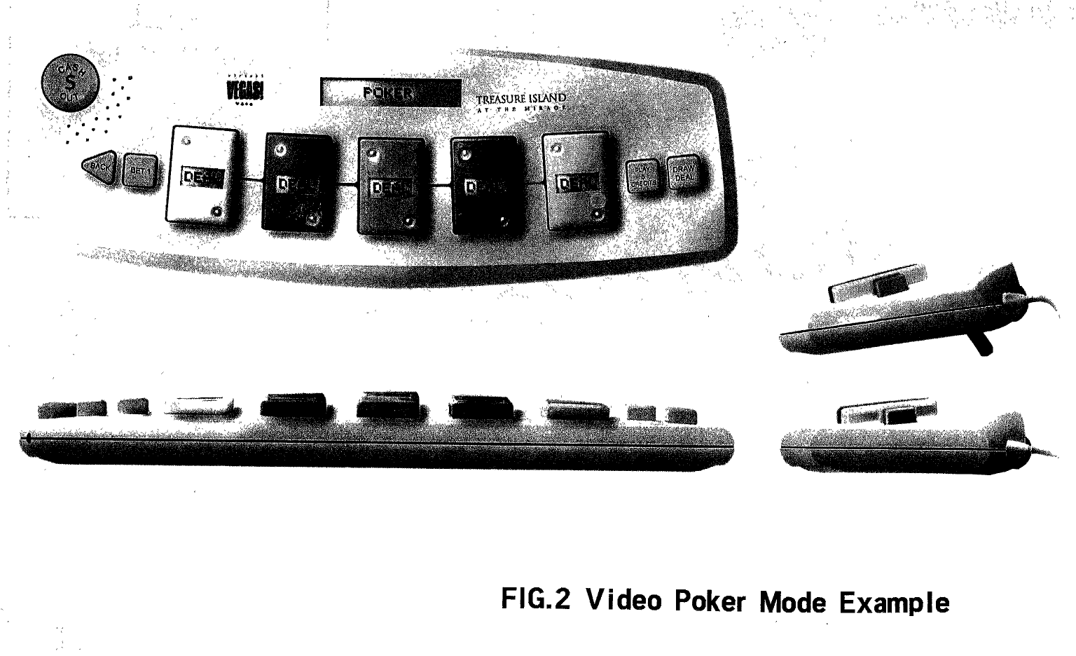

As described herein, the computer gaming keyboard is equipped with circuitry, which allows it to provide information to the host computer and receive information from the host computer regarding the gaming software being played. As an example, FIG. 2 illustrates the computer gaming keyboard in video poker mode. It can be noted that the POKER delineation can be seen in the central display window, and the DEAL request can be seen in the primary controller buttons to hold cards as in a real game of poker. Additionally, it can be noted in this example that there are numerous co-branding opportunities to further the appearance and image of a recognized casino.

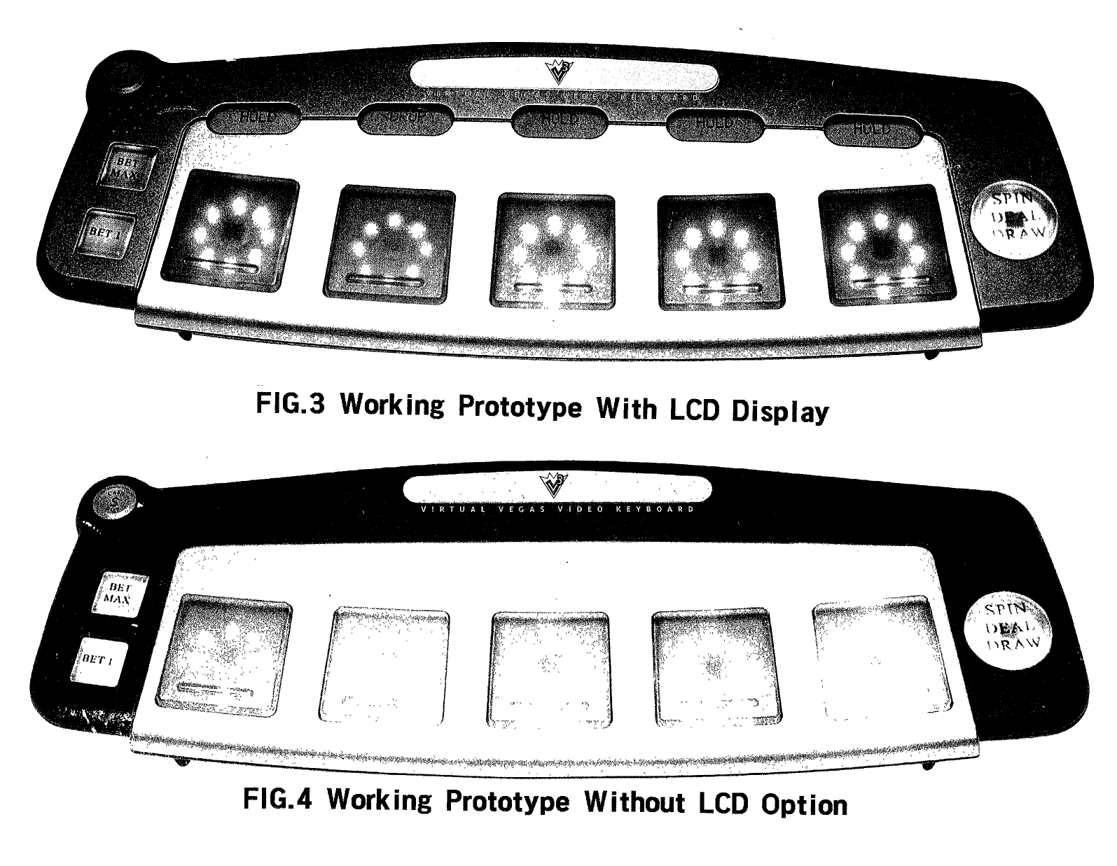

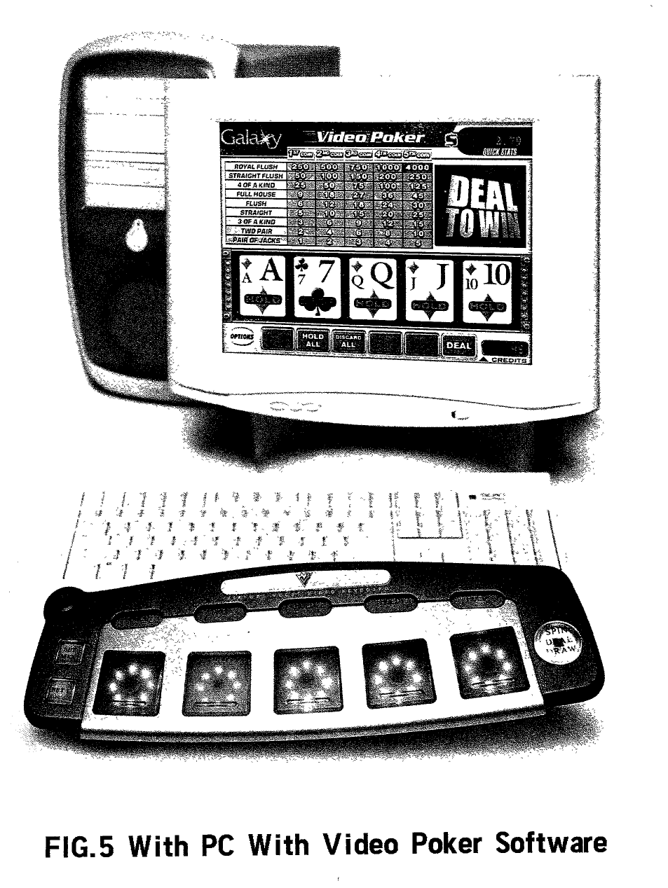

As shown in FIG. 3 and FIG. 4, there are two main varieties of computer gaming keyboard available to satisfy market demand, flexibility in game play and price points for retail distribution. FIG. 3 illustrates the working prototype considered “premium” that contains LCD display panels above the primary selection buttons. These displays clearly match up to the corresponding software images on a computer screen (see FIG. 5).

FIG. 4 shows the optional colors, branding and LCD—less display for a more economical version of the premium computer gaming keyboard. The LCD-less version of the computer gaming keyboard works fundamentally in the same way as the premium version, simply without the added feature (and expense) of the LCD display above the primary decision buttons on the unit. The hold, deal, bet functions provided by the LCD in the premium version of the computer gaming keyboard would be illustrated solely by the software image on the monitor. No other functionality would be affected in this example.

FIG. 5 illustrates the computer gaming keyboard in action. When a user boots up their computer in the course of normal computer operations, clear instruction is given then as to how to connect the computer gaming keyboard to the computer using the USB cord (included). Once the computer gaming keyboard and connected cord is attached to the central processing unit (CPU) of the computer, the operating system should automatically detect the new hardware and walk the user through a simple process of configuration prior to first time use. This set-up process would only be required upon first use of the computer gaming keyboard, and “remember” its configuration settings even after the computer has been turned off. Once the computer gaming keyboard has been configured as described, and the corresponding (any compatible) software has been loaded to the computer, the computer gaming keyboard will work as advertised.

Further illustrated in FIG. 5 is the clear matching ability to play such casino games as Video Poker as shown. The spin button is depressed the cards are then stopped or selected via the primary decision buttons. The “hold” cards are then played by standard gaming rules for the game, in this case poker. Betting is accomplished with the side buttons delineating BET 1 or BET MAX. The player can then play (per the rules governed by the software) until all of their credits have been used.

Although the foregoing descriptions and attached drawings of the present invention has shown, described and pointed out the fundamental novel features of the invention, it will be understood that various omission, substitutions and changes in the form of the detail of the apparatus as illustrated, as well as the uses thereof, may be made by those skilled in art without the departing from the spirit of the present invention. Consequently, the scope of the invention should not be limited to the foregoing discussion but should be defined by the appended claims.

What is claimed is:

1. A computer gaming keyboard comprising:
a controlling device with computer interface for playing a plurality of software enabled casino games.

2. The system of claim 1, wherein the overall size and shape of said game controlling device is approximate to that of a standard size and shaped computer keyboard.

3. The system of claim 2, wherein the computer gaming keyboard is used to enable, interface and control game play of said plurality of software.

4. The system of claim 3, wherein computer accepts standard Universal Serial Bus (USB) port interface to accept electronic signals from said gaming keyboard to operate a plurality of said software.

5. The system of claim 4, wherein any number or variety or version of software that is compatible with standard computer operating systems would be controlled as directed by computer gaming keyboard.

6. The system of claim 5, wherein said interfacing device comprises a communication device that receives signals from said gaming keyboard indicative of the performance of the player during individual games played on said gaming keyboard.

7. The system of claim 6, wherein said communication device includes a keyboard with touch key pad that, in response to manipulation of said player, provides signals to said computer.

8. The system of claim 7, wherein the said keyboard is powered by standard 120 volt electric current via standard URL approved plug and components.

9. A method of playing a hardware based computer gaming keyboard that by player manipulation controls a plurality of casino and gaming software including as example but not limited to; video blackjack, video poker, video roulette, video slot machine, and other games as are currently developed and as may developed in the future.

10. The system of claim 9, wherein the software game being played resides not on the individuals computer but in a distributed system via an Applications Solutions Provider (ASP) Internet Service Provider (ISP) or directly via the internet or world wide web.
